(19) United States
(12) Patent Application Publication
(10) Pub. No.: US 2011/0129587 A1
(43) Pub. Date: Jun. 2, 2011

(54) METHOD FOR PRODUCING SURIMI AND PASTE PRODUCT FROM FISH MEAT CONTAINING KIDNEY

(75) Inventors: Mitsutoshi KUBOTA, Hachioji-shi (JP); Satoru CHIBA, Hachioji-shi (JP)

(73) Assignee: NIPPON SUISAN KAISHA, LTD., Tokyo (JP)

(21) Appl. No.: 12/952,976

(22) Filed: Nov. 23, 2010

(30) Foreign Application Priority Data
Nov. 27, 2009 (JP) 2009-269973

(51) Int. Cl. A23L 1/325

(52) U.S. Cl. 426/574

(57) ABSTRACT

According to a method for producing a surimi by adding a protease inhibitor when producing a surimi from fish meat that contains kidney or tissue thereof, such as backbone meat, that is left over when using a filleting and deboning method to extract fillets from fish from which the head and internal organs have been removed, it is possible to produce a surimi and a paste product having stable quality from backbone meat obtained as a residue when producing fillets. The protease inhibitor is preferably a cysteine protease inhibitor.

### TECHNICAL FIELD

The present invention relates to a method for improving a gel forming ability of a fish meat surimi having low gel forming ability.

### BACKGROUND

The production of surimi (water-washed minced meat) that contains fish meat has become a global industry that operates throughout the world. In recent years, however, surimi made from previously unused raw materials has been produced for reasons such as fishing restrictions and effective use of resources.

The basic principles of surimi production are as follows. After removing the head and internal organs from the raw fish, butterfly fillets, or deboned fillets are prepared. The fillets are then placed in a separator, from which fish meat is recovered in the form of surimi. Water-soluble proteins, which inhibit the formation of gels, are removed from the proteins of this fish meat by soaking in water, skin, sinew, and bones are removed with a refiner, the fish meat is dehydrated and the myofibrillar proteins, which are the main gel forming proteins, are concentrated. This dehydrated meat is blended with a freeze-denaturation preventing agent such as a sugar or sugar alcohol and a polyphosphate and then frozen.

A basic method for producing a paste product that contains surimi is to defrost the frozen surimi to a certain extent, add salt and knead by means of a cutter and so on, blend seasonings and secondary raw materials, and then mold and heat so as to obtain a paste product. The quality of paste products is evaluated from a variety of perspectives, but of these, evaluation of gel strength is significant. In order to achieve gel formability, actomyosin that is eluted by salt grinding from myofibrils, which are the primary proteins in surimi, plays an important role. The physical properties of fish paste gels differ depending on the type of fish used, but it is known that the characteristic properties of the proteins of these fish and the enzymes contained in the fish meat have an effect on these physical properties.

Examples of fish that are often used as raw materials for surimi include Alaska pollack, Pacific whiting, Atka mackerel, sardine, horse mackerel, southern blue whiting, northern blue whiting, Atlantic cutlassfish, lizardfish, white croaker, golden threadfin bream, and splendid alfonsino.

Parasites such as myxosporidia and Ichthyophonus hoferi infest the muscles of Pacific whiting and Alaska pollack. In cases where fish infested with these parasites are used as raw materials for surimi, it is not possible to form a gel due to proteases functioning during the heating carried out in order to form fish paste gels from the surimi, thereby decomposing the primary gel proteins. In cases where surimi was produced by using meat from these fish as raw materials, a mincing technique involving the use of a protease inhibitor was established. (Patent Documents 1 and 2)

In terms of additives used to enhance the elasticity of surimi or paste products, Patent Document 3 describes that an elasticity enhancing effect is achieved by adding powdered cattle or pig plasma to a fish meat. Patent Document 4 describes improving quality by adding transglutaminase, serum, plasma, or egg albumen to fish meat.

Due to an increase in fish-eating habits in Europe and the USA in recent years, however, white fish such as Alaska pollack has come to be used not as a raw material for surimi, but as a primary raw material for block fillets for frying. In addition, the use as a raw material for surimi of backbone meat generated as a residue when producing fillets is expanding.

### RELATED ART DOCUMENTS

### Patent Documents

Patent Document 1: Japanese Unexamined Patent Application Publication No. H02-113873
Patent Document 2: Japanese Unexamined Patent Application Publication No. 2001-57872
Patent Document 3: Japanese Examined Patent Application Publication No. S59-28386
Patent Document 4: Japanese Unexamined Patent Application Publication No. H03-219854

### SUMMARY OF THE INVENTION

### Problems to be Solved by the Invention

The present invention has the object of providing a method for producing surimi having a stable quality from backbone meat generated as a residue when producing fillets. In addition, the present invention also has the object of providing a method for producing a high quality paste product by using a surimi produced from backbone meat as a raw material.

### Means for Solving the Problems

Based on the knowledge that it is not possible to produce a product having a high gel strength when producing surimi from backbone meat compared to when producing surimi from fillets, the inventors of the present invention investigated reasons and countermeasures for this, and thereby completed the present invention. As a reason for the low quality, it was found that kidney deposited on backbone meat exhibits strong protease activity and that this protease decomposes myofibrillar proteins, which are primary components of surimi. In addition, it was confirmed that this protease is a cysteine protease and a means was developed for improving the quality of the surimi by adding an additive that inhibits this activity and thereby improves the gel forming ability.

The gist of present invention is the following surimi production methods (1) to (4) and paste product production methods (5) to (8).

(1) A method for producing a surimi by adding a protease inhibitor when producing a surimi from fish meat that contains kidney or tissue thereof.

(2) The surimi production method described in (1), wherein the fish meat that contains kidney or tissue thereof is a fish meat separated from a portion which contains backbone and which is left over when using a filleting and deboning method to extract fillets from fish from which the head and internal organs have been removed.

(3) The surimi production method described in (1) or (2), wherein the protease inhibitor is a cysteine protease inhibitor.

(4) The surimi production method described in any one of (1) to (3), wherein the fish meat is codfish meat.

(5) A method for producing a paste product by adding a protease inhibitor when producing a paste product by using a surimi, which is produced from fish meat that contains kidney or tissue thereof, as a raw material.

(6) The paste product production method described in (5), wherein the fish meat that contains kidney or tissue thereof is a fish meat separated from a portion which contains backbone and which is left over when using a filleting and deboning method to extract fillets from fish from which the head and internal organs have been removed.

(7) The paste product production method described in (5) or (6), wherein the protease inhibitor is a cysteine protease inhibitor.

(8) The paste product production method described in any one of (5) to (7), wherein the fish meat is codfish meat.

### Effect of the Invention

According to the production methods of the present invention, it is possible to increase the gel forming ability of a surimi or paste product that contains backbone meat as a raw material, which had low gel forming ability due to the action of protease derived from kidney, that is, it is possible to produce a high quality surimi or paste product.

### BRIEF DESCRIPTION OF THE DRAWINGS

FIG. 1 is a photograph of the backbone meat of a fish.

FIG. 2 is a photograph that shows the results of SDS-PAGE electrophoresis carried out in Working Example 1 in order to compare the state of myofibrillar protein decomposition caused by various internal organs of Alaska pollack.

FIGS. 3 (a) and (b) are photographs that show the results of SDS-PAGE electrophoresis carried out in Working Example 2 in order to confirm the protease types of myofibrillar protein-decomposing enzymes contained in kidney.

FIG. 4 is a graph that compares the protease activity and gel strength of surimi containing backbone meat as a raw material and surimi containing fillet as a raw material.

### DETAILED DESCRIPTION OF PREFERRED EMBODIMENTS

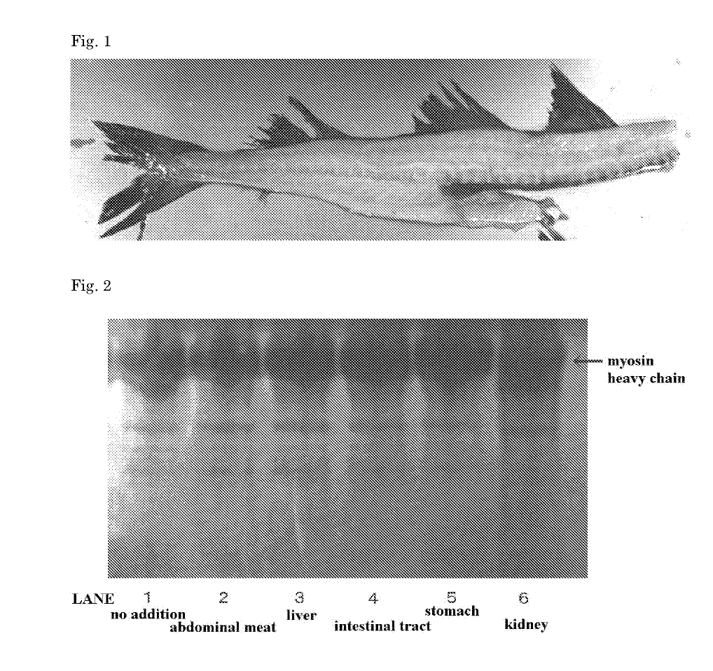

In cases where fillets are produced from fish, butterfly fillets, or deboned fillets are prepared after the head and internal organs are removed from the raw fish. In such cases, portions including backbone, meat from around the backbone, fin, and so on are generated as residues, as shown in FIG. 1. Kidney is deposited on the lower part of the backbone (the red portion in the photograph, or the black portion in the black and white photograph). Even if the other internal organs are removed, kidney is deposited on the backbone and therefore is not removed and remains on the backbone. It is possible to extract fish meat after removing this portion, but this is time-consuming and it is difficult to completely preventingredients of kidney from being deposited on the fish meat during this process.

The present invention is a method for improving quality when producing a surimi or paste product by using this type of backbone meat (meat remaining around the backbone after extracting the fillets) as a raw material.

It was understood that surimi produced from meat from around the backbone has a lower gel forming ability than surimi produced from fillets even in the case of fish meat obtained from the same type of fish, and as a result of investigating the reasons for this, it was found that the high protease activity of kidney is a reason for this, as demonstrated in the working examples. In the past, it was thought that digestive organs such as the stomach and intestines contain proteases as digestive enzymes, but it was not known that kidney had such high protease activity. The fact that the protease activity of kidney is extremely high and is a cause of low surimi quality was first confirmed by the inventors of the present invention.

In the specification of the present invention, protease activity means a value calculated in terms of specific activity per unit concentration of protein by adding a four-fold excess of a buffer (0.1 M NaCl, 20 mM Tris-HCl, pH 7.5) to a quantity of surimi and homogenizing, reacting for 1 hour at 60° C., carrying out TCA treatment, and carrying out colorimetry/quantitative determination of the quantity of peptides (proteolysis products) in the TCA-soluble fraction by means of a phenol reagent.

As shown in the working examples, the protease activity of surimi that contains backbone meat as a raw material is a specific activity of approximately 0.001 to 0.002. However, the specific activity of surimi that contains fillet as a raw material is 0.0005 or lower.

Gel strength is used as an indicator of the gel forming ability of a surimi, that is, as an indicator of the elasticity of a paste product. In general, this is represented by the product of the breaking strength (W value (g)) and the distance until breaking (L value (cm)) of a paste product (W value×L value). J.S. (Jelly Strength) is used as an indicator of gel strength in the present invention.

As a result of using a variety of inhibitors to investigate what type of proteases are contained in backbone meat, it was found that cysteine proteases are contained therein, and by considering that it may be possible to improve the gel forming ability of backbone meat by means of cysteine protease inhibitors, the inventors of the present invention completed the present invention.

The protease inhibitors in the present invention can be any having protease inhibitor activity and able to be used in foods. Inhibitors exhibiting strong cysteine protease inhibitor activity are preferred, but it is also possible to use an inhibitor that exhibits inhibitor activity against a plurality of proteases, such as egg albumen. Because many foods having protease inhibitor activity are known, it is possible to refine and use these foods.

Specifically, inhibition can be achieved by using foods that exhibit protease inhibitor activity, such as rice bran extract (Japanese Patent No. 3676296), egg albumen, whey, and plasma protein. As shown in the working examples, it was confirmed that gel strength is restored by adding these foods to surimi derived from backbone meat. Specifically, these foods and food additives that exhibit a protease inhibitor effect are used as additives that inhibit protease activity and thereby cause the gel forming ability to be restored in the present invention.

A process for producing surimi from backbone meat is as described below.

Fish meat, which contains kidney, is recovered by placing backbone meat in a separator (Otoshimi in Japanese, ground meat). Water-soluble proteins, which inhibit the formation of gels, are removed from the proteins of this fish meat by soaking in water, skin, sinew and bones are removed with a refiner, the fish meat is dehydrated and the myofibrillar proteins, which are the main gel forming proteins, are concentrated. This dehydrated meat is blended with a freeze-denaturation preventing agent such as a sugar or sugar alcohol and a polyphosphate and then frozen.

Some of the proteases derived from kidney contained in the fish meat are removed by being soaked in water, but it is not possible to completely remove the proteases derived from kidney.

The process of adding the protease inhibitor can be carried out at any stage of the surimi production, but can be, for example, added to the ground meat, added to the water soaking liquid, or added to the dehydrated meat. The protease inhibitor can be added at any stage, but it is logical to add the protease inhibitor when other additives are added to the dehydrated meat.

In addition, when producing a paste product by using surimi produced from backbone meat, it is possible to add a food or food additive that exhibits a protease inhibitor effect.

In the present invention, fish meat paste products means ordinary seafood past products having fish meat as a primary ingredient, such as kamaboko (steamed fish paste), chikuwa (fish sausage), satsuma-agé (deep fried minced fish and/or vegetables), imitation crab sticks, and fish meat sausages. Fish meat paste products are produced by adding secondary raw materials such as starch, gluten, common salt, sugars, sugar alcohols, seasonings, spices, and food colorings to fish meat. The surimi used as a raw material for a paste product is produced by, for example, separating meat from the raw fish, soaking this meat in water, dehydrating, and then grinding. Otoshimi (ground meat) that is not soaked in water can also be used as a raw material for paste products. The paste product is produced by, for example, adding secondary raw materials to surimi or otoshimi, grinding, seasoning, molding, heating, and then cooling. After the molding step, a gelation step is generally carried out for a period of between 10 minutes and 20 hours at a temperature of 15 to 50° C., and preferably 20 to 40° C., by which the elasticity of the fish meat is increased.

Based on the method of the present invention, in cases where an inhibitor is added, the inhibitor should be added before the heating step in the above-mentioned paste product production method. Realistically, the inhibitor is preferably (1) blended with the dehydrated meat, or (2) blending during the grinding step in the paste product production method.

The quantity of protease inhibitor added depends on the activity of the protease inhibitor used and the strength of protease activity in the surimi, but in the case of food materials and additives known to exhibit protease inhibitor activity, a satisfactory effect is achieved at a quantity of 0.01 to 3 wt. %, and preferably approximately 0.1 to 1.0 wt. %, relative to the quantity of fish meat.

In the case of rice bran extract also, a satisfactory effect is achieved at a quantity of 0.01 to 3 wt. %, and preferably approximately 0.1 to 1.0 wt. %, relative to the quantity of fish meat. In terms of the content of oryzacystatin, which is known as a protease inhibitor contained in rice bran extract, the added quantity is 0.015 to 4.5 ppm, and preferably 0.15 to 1.5 ppm, relative to the quantity of fish meat. In the case of egg albumen also, a satisfactory effect is achieved at a quantity of 0.01 to 3 wt. %, and preferably approximately 0.1 to 1.0 wt. %, relative to the quantity of fish meat.

Rice bran extract is an extract that contains water-soluble components of rice bran. These can be refined, concentrated and used as an indicator of protease inhibitor activity. In particular, it is preferable to remove or reduce the content of dietary fiber, which is contained in large quantities in rice bran. It is possible to use refined oryzacystatin or the “rice bran extract from which phytin and/or phytic acid has been removed or reduced in content” or “rice bran extract from which gelation-inhibiting components have been removed or reduced in content by precipitation or dialysis” disclosed in Japanese Patent no. 3676296 and so on.

The present invention will now be explained in greater detail through the use of working examples, but is in no way limited to these working examples. The rice bran extract used in the working examples is produced using the method disclosed in Japanese Patent no. 3676296, that is, by subjecting rice bran to extraction with water and then membrane filtration, thereby removing low molecular weight components such as phytin and phytic acid, concentrating the high molecular weight fraction and then drying, by which the rice bran extract has an oryzacystatin content of 150 ppm.

### Working Example 1

### Observation of Myofibrillar Protein Decomposition Caused by Different Internal Organs of Alaska Pollack

The myofibrillar protein decomposition ability of internal organs (abdominal meat, liver, intestinal tract, stomach, kidney) of Alaska pollack was observed. A quantity of the sampled internal organ was homogenized with twice the quantity thereof of water and subjected to centrifugal separation (2000 G, 10 minutes), and the supernatant liquid was recovered and used as the extract. 10 μL of the extract was added to 1 mL of a solution of myofibrillar protein prepared from Alaska pollack and incubated for 20 minutes at 30° C. so as to bring about a decomposition reaction. This was then subjected to SDS-PAGE, and the band patterns of the proteins were compared.

As a result of observing the band patterns shown in FIG. 2, it was confirmed that decomposition of the myosin heavy chain, which is the primary component of myofibrillar proteins, occurred only when the kidney extract was added. This confirmed that kidney exhibits strong protease activity and that this protease decomposes myofibrillar proteins, which are the primary component of surimi.

### Working Example 2

### Identification Of Protease Types Of Myofibrillar Protein-Decomposing Enzymes Contained in Kidneys

The protease types of myofibrillar protein-decomposing enzymes contained in kidney were identified as follows. The kidney was homogenized with twice the quantity thereof of water and subjected to centrifugal separation (2000 G, 10 minutes), and the supernatant liquid was recovered and used as the extract. 10 μL of this extract was added to 1 mL portions of a solution of myofibrillar protein prepared from Alaska pollack, 4 types of protease inhibitor reagents, E-64 (produced by Peptide Institute, Inc., final concentration 1 mM), which is a cysteine protease inhibitor, 1,10-phenanthroline (produced by Wako Pure Chemical Industries, Ltd., final concentration 1 mM), which is a metalloprotease inhibitor, p-APMSF (produced by Wako Pure Chemical Industries, Ltd., final concentration 10 mM), which is a serine protease inhibitor, and Pepstatin A (produced by Peptide Institute, Inc., final concentration 1 mM), which is an acidic protease inhibitor, were added to these portions and incubated for 20, 60, and 120 minutes at 30° C. so as to bring about a decomposition reaction. These were then subjected to SDS-PAGE and the band patterns of the proteins were compared.

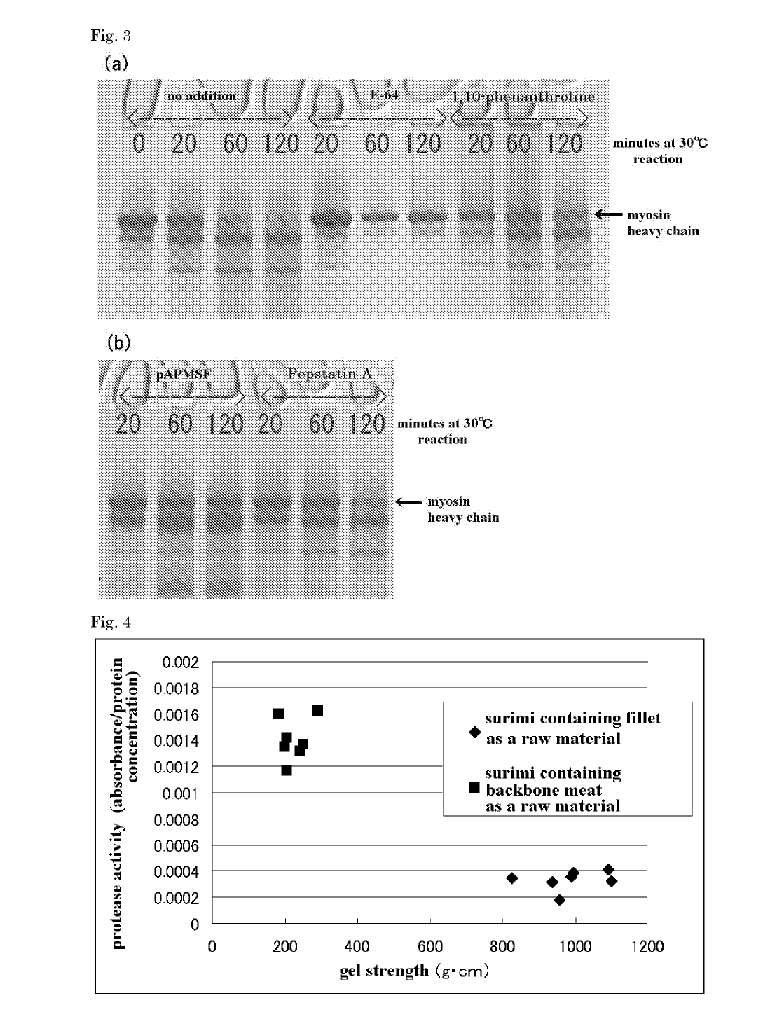

As shown in FIG. 3, it was confirmed that decomposition of the myosin heavy chain, which is the primary component of myofibrillar proteins, was inhibited only when E-64, which is a cysteine protease inhibitor, was added. As a result, it was confirmed that the protease types of myofibrillar protein-decomposing enzymes contained in kidneys were cysteine proteases.

### Working Example 3

### Protease Activity and Gel Strength of Surimi Containing Backbone Meat as a Raw Material and Surimi Containing Fillet as a Raw Material

Using a filleting and deboning machine (Baader 212 manufactured by Baader (Germany)), Alaska pollack were separated into backbone meat and fillets, ground meat was recovered from both the backbone meat and the fillets using a separator (Baader 607 manufactured by Baader (Germany)), this ground meat was soaked in water, subjected to refining, dehydrated, added to sugar and a polyphosphate, and then frozen so as to obtain frozen surimi. Seven batches of the surimi containing backbone meat as a raw material and seven batches of the surimi containing fillet as a raw material were produced, and the protease activity and gel strength of the obtained surimis were measured.

The protease activity was calculated in terms of specific activity per unit concentration of protein by adding a four-fold excess of a buffer (0.1 M NaCl, 20 mM Tris-HCl, pH 7.5) to a quantity of surimi and homogenizing, reacting for 1 hour at 60° C., carrying out TCA treatment and carrying out colorimetry/quantitative determination of the quantity of peptides (proteolysis products) in the TCA-soluble fraction by means of a phenol reagent.

The gel strength was calculated by adding 5 g of common salt to the surimi and then salt grinding so as to produce ground meat, placing this ground meat in a polyvinylidene chloride tube, heating for 40 minutes at 90° C., and then cooling to as to prepare kamaboko (steamed fish paste). The physical properties of the obtained kamaboko were measured by a food checker using a plunger having a diameter of 5 mm, and the gel strength was calculated from the strength at which the kamaboko broke (W value (g)) and the distance until breaking (L value (cm)) (W value×L value).

Table 1 shows the average analysis values of the 7 batches and FIG. 3 shows a plot of gel strength versus protease activity for each batch. The gel strength of the surimi containing fillet as a raw material was approximately 4 times as high as the surimi containing backbone meat as a raw material. However, the protease activity of the surimi containing fillet as a raw material was approximately one quarter that of the surimi containing backbone meat as a raw material.

Despite being produced from meat from the same type of fish, the reason for such differences is that because kidney is deposited on the backbone meat, the surimi containing backbone meat as a raw material exhibits higher protease activity, the protease functions when the ground meat is heated, thereby decomposing myofibrillar proteins, which are primary components of surimi, and reducing the gel strength.

TABLE 1

| | gel | protease activity |
|---|---|---|
| | strength | (absorbance/ |
| | (g · cm) | protein concentration) |
| surimi containing fillet as a raw material | 985 | 0.00033 |
| surimi containing backbone meat as a | 226 | 0.0014 |
| raw material | | |

### Working Example 4

### Addition of Protease Inhibitors to Surimi Containing Backbone Meat as a Raw Material

Frozen surimi containing backbone meat as a raw material was prepared using a routine method, and the gel strength of this surimi was measured in the same way as in Working Example 3. Moreover, rice bran extract or egg albumen, which are protease inhibitors, were added in a secondary raw material blending step in the frozen surimi production method. The rice bran extract was added at 0.3% relative to the quantity of dehydrated meat and the egg albumen was added at 0.25% relative to the quantity of dehydrated meat.

Table 2 shows the gel strength measurement results, from which it was confirmed that the addition of a protease inhibitor such as rice bran extract or egg albumen increases the gel strength from 258 g·cm to approximately 400 g·cm. This is thought to be because the activity of the proteases contained in the surimi containing backbone meat as a raw material is inhibited by the protease inhibitor, thereby preventing the decomposition of myofibrillar proteins, which are primary components of surimi, from occurring. This shows that the addition of a protease inhibitor such as rice bran extract or egg albumen enables an improvement in the quality of surimi containing backbone meat as a raw material.

TABLE 2

| | Wvalue | L value | gel strength |
|---|---|---|---|
| | (g) | (cm) | (g · cm) |
| no inhibitor | 315 | 0.82 | 258 |
| rice bran extract added | 427 | 0.95 | 405 |
| egg albumen added | 392 | 1.02 | 400 |

### Working Example 5

### Effect on Kamaboko (Steamed Fish Paste) Produced From Surimi Containing Backbone Meat as a Raw Material

Frozen surimi containing backbone meat as a raw material and produced in the same way as in Working Example 3 was defrosted, coarsely ground using a silent cutter, and salt ground (by adding 3 wt. % of common salt) so as to prepare ground meat. During the salt grinding, rice bran extract was added to the fish meat according to the blending quantities shown in Table 3.

Kamaboko was prepared by placing the ground meat in a polyvinylidene chloride film and heating for 40 minutes at 90° C. Next, the gel strength of the obtained kamaboko was measured. The gel strength was calculated in terms of J.S. (g·cm) by cutting the above-mentioned kamaboko into round slices 2.5 cm thick and then multiplying the breaking strength (W value (g)), which is measured using a plunger having a diameter of 5 mm, by the distance until breaking (I, value (cm)).

The results are shown in Table 3. It was confirmed that adding rice bran extract increases gel strength, and this increase reaches its peak when 0.75 wt. % is added. This shows that adding a protease inhibitor when producing a paste product from surimi containing backbone meat as a raw material enables an increase in the quality of the paste product.

TABLE 3

| | sample No. | | | | | |
|---|---|---|---|---|---|---|
| | 1 | 2 | 3 | 4 | 5 | 6 |
| rice bran | 0.0 | 0.1 | 0.3 | 0.5 | 0.75 | 1.0 |
| extract | | | | | | |
| (% by weight) | | | | | | |
| W value (g) | 327 | 363 | 452 | 528 | 523 | 514 |
| L value (cm) | 0.81 | 0.90 | 1.02 | 1.08 | 1.10 | 1.05 |
| JS (g · cm) | 263 | 326 | 461 | 568 | 576 | 538 |

### INDUSTRIAL APPLICABILITY

According to the methods of the present invention, it is possible to provide a high quality surimi from a raw material such as backbone meat, from which only low quality surimi could be produced in the past, and thereby improve the quality of paste products.

What is claimed is:

1. A method for producing a surimi comprising adding a protease inhibitor when producing a surimi from fish meat that contains kidney or tissue thereof.

2. The method for producing a surimi described in claim 1, wherein the fish meat that contains kidney or tissue thereof is a fish meat separated from a portion which contains backbone and which is left over when using a filleting and deboning method to extract fillets from fish from which the head and internal organs have been removed.

3. The method for producing a surimi described in claim 1, wherein the protease inhibitor is a cysteine protease inhibitor.

4. The method for producing a surimi described in claim 1, wherein the fish meat is codfish meat.

5. A method for producing a paste product comprising adding a protease inhibitor when producing a paste product by using a surimi, which is produced from fish meat that contains kidney or tissue thereof, as a raw material.

6. The method for producing a paste product described in claim 5, wherein the fish meat that contains kidney or tissue thereof is a fish meat separated from a portion which contains backbone and which is left over when using a filleting and deboning method to extract fillets from fish from which the head and internal organs have been removed.

7. The method for producing a paste product described in claim 5, wherein the protease inhibitor is a cysteine protease inhibitor.

8. The method for producing a paste product described in claim 5, wherein the fish meat is codfish meat.
